(19) United States
(12) Patent Application Publication
(10) Pub. No.: US 2010/0167738 A1
(43) Pub. Date: Jul. 1, 2010

(54) SYSTEM AND METHOD FOR NETWORK REGISTRATION IN MOBILE TELECOMMUNICATIONS

(75) Inventor: Tae Wan KIM, Gunpo-si (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/637,173

(22) Filed: Dec. 14, 2009

(30) Foreign Application Priority Data
Dec. 26, 2008 (KR) 10-2008-0134239

(51) Int. Cl. H04W 8/02

(52) U.S. Cl. 455/435.2

(57) ABSTRACT

In a system and a method for a network registration in mobile telecommunications, a multi-mode public land mobile network (PLMN) status is checked in a region where a terminal is located. If a requested PLMN in charge of the communication region where the terminal is located provides PLMN information to the terminal, the PLMN information on the requested PLMN and on other PLMNs adjacent to the terminal and in a region near the requested PLMN may be provided to the terminal so that the selected PLMN may be identified from an available PLMN list obtained from the PLMN information. Thus, a selected PLMN corresponding to a network registration object may be selected for network registration request.

### CROSS-REFERENCE TO RELATED APPLICATION

This application claims priority from and the benefit of Korean Patent Application No. 10-2008-0134239, filed on Dec. 26, 2008, which is hereby incorporated by reference for all purposes as if fully set forth herein.

### BACKGROUND

1. Field of the Invention

This disclosure relates to a system and a method for network registration in mobile telecommunications, and more particularly, to a system and a method for network registration in mobile telecommunications by checking a multi-mode public land mobile network (PLMN) status in a region where a terminal is located and selecting a PLMN corresponding to a network registration object.

2. Discussion of the Background

In a telecommunication environment where a second-generation (2G) public land mobile network (PLMN) and a third-generation (3G) PLMN both exist, a terminal having a multi-mode and multi-band function of communicating with both the 2G and 3G PLMNs performs a network registration when the terminal is turned on to be booted.

When the terminal performs the network registration, the terminal selects an available PLMN from the 2G and 3G PLMNs existing in the region where the terminal is located, and performs the network registration to the selected PLMN by transmitting a network registration request message to the selected PLMN.

The network registration may be performed on the basis of a predetermined protocol. FIG. 1 is a diagram showing a network registration process to a multi-mode public land mobile network (PLMN) according to the prior art. As shown in FIG. 1, inside the terminal, the network registration to the PLMN is performed by Non Access Stratum (NAS) 10 and Access Stratum (AS) 20.

The NAS 10 corresponds to a layer in charge of a signaling request of the terminal, and the AS 20 corresponds to a layer that transmits the signaling request generated from the NAS 10 to the PLMN.

To begin, an event requesting the network registration of the terminal is generated. For example, the NAS 10 may request the network registration to the 3G PLMN on the basis of 3G PLMN information for the most recent network registration (Step S11). The NAS 10 sends a network registration request for the 3G PLMN to the AS 20. Then, the AS 20 requests the network registration to the 3G PLMN by transmitting the network registration request message for requesting the network registration to the 3G PLMN. If the AS 20 fails in the network registration to the 3G PLMN (Step S13), the AS 20 notifies the NAS 10 of the network registration failure and provides an available 3G PLMN list to the NAS 10 on the basis of the 3G PLMN information acquired from the PLMN in the region where the terminal is located (Step S15).

Then, the NAS 10 stores the available 3G PLMN list provided from the AS 20 (Step S17), and requests the network registration to the 2G PLMN on the basis of 2G PLMN information for the most recent network registration (Step S19). The NAS 10 sends a network registration request for the 2G PLMN to the AS 20. Then, the AS 20 requests the network registration to the 2G PLMN by transmitting the network registration request message for requesting the network registration to the 2G PLMN. If the network registration to the 2G PLMN fails (Step S21) due to, for example, the non-existence of the 2G PLMN in the vicinity of the terminal, the AS 20 notifies the NAS 10 of the network registration failure and provides an available 2G PLMN list to the NAS 10 on the basis of 2G PLMN information acquired from the PLMN in the region where the terminal is located (Step S23). The 2G PLMN list may include information showing the non-existence of the 2G PLMN in the vicinity of the terminal.

Accordingly, the NAS 10 compares the 3G PLMN list provided from the AS 20 in Step S15 with the 3G PLMN list stored in a Subscriber Identity Module (SIM) card of the terminal and may select a 3G PLMN on the basis of the highest-level 3G PLMN identification information existing in the SIM card among the same 3G PLMN identification information (Step S25). Then, the NAS 10 requests the network registration to the selected 3G PLMN (Step S27). Then, the AS 20 performs the network registration by transmitting the network registration request message in accordance with the network registration request of the NAS 10 to the selected 3G PLMN.

As described above for a case where the network registration is performed by the NAS 10 and the AS 20 inside the terminal, when the network registration to the PLMN fails, the AS 20 separately acquires the 2G PLMN information and the 3G PLMN information provided from the PLMNs located in the vicinity of the terminal and separately provides the available 2G PLMN list and the 3G PLMN list to the NAS 10. Thus, PLMN information on only the 2G PLMN or 3G PLMN which is used for the network registration is provided to the NAS 10. Accordingly, to obtain the information on both 2G PLMNs and 3G PLMNs existing in the vicinity of the terminal, the terminal separately attempts the network registration to the 2G and 3G PLMNs. This process may increase the time for the terminal to obtain the information on both 2G PLMNs and 3G PLMNs existing in the vicinity of the terminal, and may increase the network registration time.

### SUMMARY

Exemplary embodiments of the present invention provide a system and a method for a network registration in mobile telecommunications by receiving information on PLMNs in a multi-mode PLMN region adjacent to the terminal, even if such PLMNs are associated with different modes or generations, when a PLMN provides PLMN information to the terminal.

Additional features of the invention will be set forth in the description which follows, and in part will be apparent from the description, or may be learned by practice of the invention.

An exemplary embodiment of the present invention discloses a system to perform a network registration to a multi-mode public land mobile network (PLMN). The system includes: a first PLMN to transmit PLMN information including first PLMN information and second PLMN information on a second PLMN in a region near the first PLMN, the first PLMN corresponding to a first mode and the second PLMN corresponding to a second modes; and a terminal to obtain an available PLMN list by acquiring the PLMN information from the first PLMN, to select the second PLMN corresponding to a network registration object by referring to the available PLMN list, and to attempt a network registration to the second PLMN.

An exemplary embodiment of the present invention discloses a terminal to perform a network registration, including a processor, a radio frequency transmitter/receiver, and a Non Access Stratum (NAS) and an Access Stratum (AS). The terminal receives public land mobile network (PLMN) information from a first PLMN, the PLMN information including first PLMN information and second PLMN information on a second PLMN in a region near the first PLMN, obtains an available PLMN list from the PLMN information, selects the second PLMN corresponding to a network registration object by referring to the available PLMN list, and attempts a network registration to the second PLMN. Further, the first PLMN corresponds to a first mode and the second PLMN corresponds to a second mode.

An exemplary embodiment of the present invention discloses a public land mobile network (PLMN) for a network registration in mobile telecommunications. The PLMN includes a radio frequency transmitter/receiver, a processor, and a memory to store PLMN information including its own PLMN information and information on a second PLMN in a region near the PLMN. Further, the PLMN transmits the PLMN information to a terminal if a network registration to the PLMN by the terminal fails.

An exemplary embodiment of the present invention discloses a method for a network registration to a multi-mode PLMN, including: attempting a network registration to a first PLMN; receiving PLMN information including first PLMN information and second PLMN information on a second PLMN in a region near the first PLMN if the network registration to the first PLMN fails; obtaining an available PLMN list from the PLMN information; and attempting the network registration to the second PLMN selected as a network registration object by referring to the available PLMN list. Further, the first PLMN corresponds to a first mode and the second PLMN corresponds to a second mode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing a network registration process to a multi-mode public land mobile network (PLMN) according to the prior art.

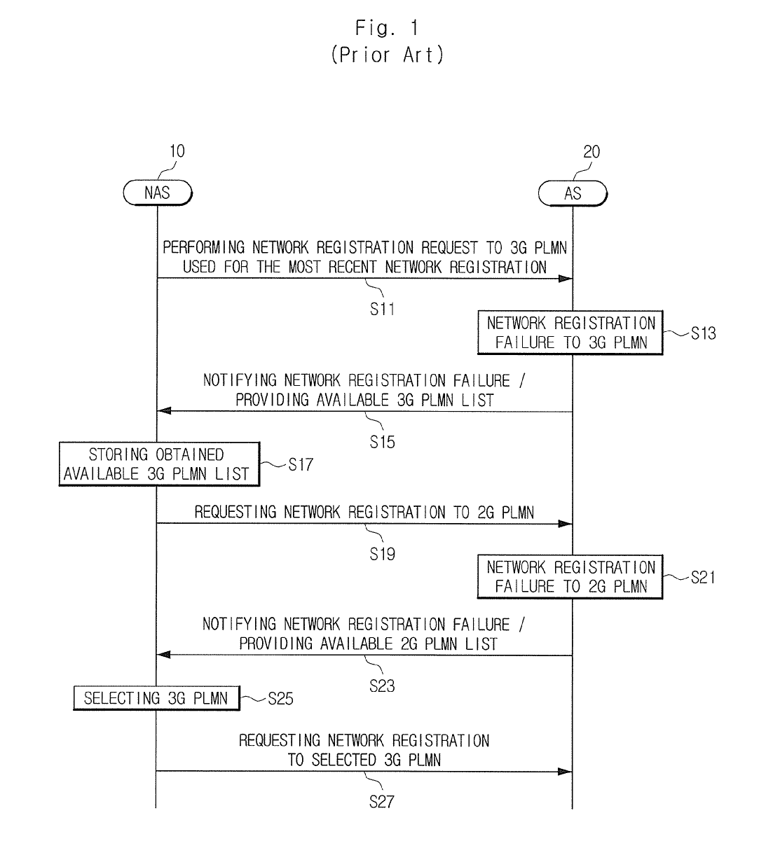

FIG. 2 is a diagram showing a network registration process to a multi-mode public land mobile network (PLMN) according to an exemplary embodiment.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the shape, size, and relative sizes of regions may be exaggerated for clarity. Like reference numerals in the drawings denote like elements.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, an exemplary embodiment will be described in detail with reference to the accompanying drawing.

Referring to an exemplary embodiment, a PLMN that provides PLMN information to a terminal provides information on other PLMNs adjacent to the terminal and which are capable of communicating with the terminal. The PLMN stores the PLMN information on other PLMNs located adjacent to the PLMN in a base station or a base station controller. If the PLMN transmits the PLMN information to the terminal existing in its communication region via the base station, the PLMN wirelessly transmits information on other adjacent PLMNs to the terminal as well.

Accordingly, information on other adjacent PLMNs to the terminal can be provided while providing the PLMN information to the terminal existing in the communication region of the PLMN.

In this way, if a first PLMN provides PLMN information to the terminal, the first PLMN can provide information on PLMNs of other modes to the terminal together with its own PLMN information. For example, if a 2G PLMN provides the PLMN information to the terminal, the 2G PLMN may provide the PLMN information on an adjacent 3G PLMN to the terminal together with the information on the 2G PLMN. And if the 3G PLMN provides the PLMN information to the terminal in its communication region via the base station, the 3G PLMN transmits the information on other 2G PLMNs in the vicinity of the terminal together with the information on other 3G PLMNs in the vicinity of the terminal.

In addition, if the first PLMN provides the PLMN information to the terminal, identification information for the first PLMN is included in the PLMN information. If other PLMNs exist adjacent to the first PLMN and the terminal, identification information for the other adjacent PLMNs is included in the PLMN information sent from the first PLMN. As an example, if the 3G PLMN provides the PLMN information to the terminal, the identification information for the 3G PLMN and the identification information for other adjacent 2G or 3G PLMNs existing in the vicinity of the 3G PLMN are included in the PLMN information provided to the terminal.

Further, if the PLMN provides the PLMN information to the terminal, the PLMN information of cells in the vicinity of the PLMN is provided to the terminal via the base station and a broadcast control channel (BCCH).

Furthermore, if a terminal requests a network registration to a PLMN and the network registration attempt to the PLMN fails, the terminal receives the PLMN information including other adjacent PLMNs provided from the requested PLMN via the BCCH. Then, the terminal may check a PLMN status in the region where the terminal is located on the basis of the PLMN information.

If a network registration is attempted to the PLMN by the terminal, the network registration may be performed on the basis of a predetermined protocol. Inside the terminal, the procedure of the network registration to the PLMN is performed by Non Access Stratum (NAS) and AS (Access Stratum). The NAS corresponds to a layer in charge of a signaling request of the terminal, and the AS corresponds to a layer that transmits the signaling request generated from the NAS to the PLMN.

If an event requesting the network registration by the terminal is generated, the NAS requests the network registration to the PLMN on the basis of the PLMN information for the most recent network registration, and sends a network registration request to the AS. Then, the AS requests the network registration by transmitting a network registration request message to the PLMN. If the network registration to the PLMN fails, the AS notifies the NAS of the network registration failure and provides an available PLMN list to the NAS on the basis of the PLMN information acquired from the PLMN for the region where the terminal is located.

If the network registration attempted to the PLMN in accordance with the network registration request from the NAS fails, the AS provides the available PLMN list to the NAS on the basis of the PLMN information acquired from the PLMN, which may be in charge of the communication region where the terminal is located. The PLMN information includes information of other PLMNs adjacent to the requested PLMN in the communication region where the terminal is located from the requested PLMN, and the AS provides the available PLMN list to the NAS on the basis of the acquired PLMN information.

For example, if only a 3G PLMN exists in the vicinity of the terminal, the AS acquires only the 3G PLMN information. Then, the AS notifies the NAS of the available PLMN list including the 3G PLMN information and information showing the non-existence of the 2G PLMN. On the other hand, if only a 2G PLMN exists in the vicinity of the terminal, the AS acquires only the 2G PLMN information. Then, the AS notifies the NAS of the available PLMN list including the 2G PLMN information and information showing the non-existence of the 3G PLMN.

The NAS compares the available PLMN list provided from the AS with the PLMN list stored in a Subscriber Identity Module (SIM) card of the terminal, selects a PLMN on the basis of the highest-level PLMN identification information existing in the SIM card among the same PLMN identification information, and requests the AS that the network registration be attempted to the selected PLMN. Accordingly, the network registration may be performed by transmitting the network registration request message from the AS to the PLMN.

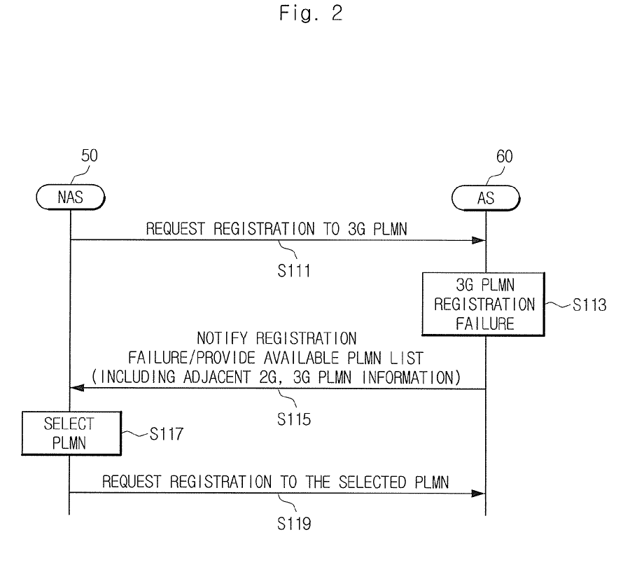

FIG. 2 is a diagram showing a network registration process to a multi-mode public land mobile network (PLMN) according to an exemplary embodiment.

If a terminal having the above-described structure and function attempts the network registration to the PLMN, the network registration may be performed as shown in FIG. 2.

Referring to FIG. 2, an event requesting the network registration of the terminal is generated, for example, the NAS 50 requests the network registration to the 3G PLMN on the basis of the 3G PLMN information for the most recent network registration (Step S111). The NAS 50 sends a network registration request to the AS 60. Then, the AS 60 requests the network registration to the 3G PLMN by transmitting the network registration request message for requesting the network registration to the 3G PLMN. If the network registration to the 3G PLMN fails (Step S113), the AS 60 notifies the NAS 50 of the network registration failure and provides the available PLMN list to the NAS 50 on the basis of 2G PLMN information and 3G PLMN information acquired from the requested PLMN in the region where the terminal is located (Step S115).

Then, the NAS 50 compares the available PLMN list provided from the AS 60 with the PLMN list, which may be stored in the SIM card of the terminal, and selects the 2G PLMN or 3G PLMN. The 2G PLMN or 3G PLMN may be selected on the basis of the highest-level PLMN identification information existing in the SIM card among the same PLMN identification information (Step S117). When the NAS 50 requests the network registration to the selected 2G PLMN or 3G PLMN (Step S119), the AS 60 performs the network registration by transmitting the network registration request message to the 2G PLMN or 3G PLMN generated from the NAS 50 to the selected PLMN.

As described above, the requested PLMN provides its PLMN information to the terminal via the BCCH along with information on other PLMNs adjacent to the requested PLMN. The AS 60 attempts the network registration to the 3G PLMN on the basis of the network registration request to the 3G PLMN generated from the NAS 50 in Step S113. If the network registration fails, as described above, the AS 60 notifies the NAS 50 of the network registration failure and provides the available PLMN list acquired on the basis of the PLMN information provided from the requested 3G PLMN in the communication region where the terminal is located. The NAS 50 compares the available PLMN information notified from the AS 60 with the available PLMN information stored in the SIM card, selects the PLMN on the basis of the highest-level PLMN identification information existing in the SIM card among the same PLMN identification information, and requests the AS 60 to attempt the network registration to the selected PLMN.

If only the 3G PLMN exists in the vicinity of the terminal, the AS 60 acquires only the 3G PLMN information. In this case, the AS 60 notifies the NAS 50 of the available PLMN list including the 3G PLMN information and the information showing the non-existence of the 2G PLMN. On the other hand, if only the 2G PLMN exists in the vicinity of the terminal, the AS 60 acquires only the 2G PLMN information. In this case, the AS 60 notifies the NAS 50 of the available PLMN list including the 2G PLMN information and the information showing the non-existence of the 3G PLMN.

Then, the NAS 50 selects the PLMN for the network registration in Step S117 on the basis of the available PLMN list obtained when the AS 60 notifies the NAS 50 of the network registration failure. For example, if only the 3G PLMN information exists as a result of checking the obtained available PLMN list, the PLMN for the network registration is selected from the 3G PLMNs. The 3G PLMN stored as the highest-level PLMN in the SIM card may be selected from among the 3G PLMNs of the available PLMN list. On the other hand, if only the 2G PLMN information exists as a result of checking the obtained available PLMN list, the PLMN for the network registration is selected from the 2G PLMNs. The 2G PLMN stored as the highest-level PLMN in the SIM card may be selected from among the 2G PLMNs of the available PLMN list. Thus, the PLMN as the network registration object is selected. Then, the NAS 50 requests the AS 60 to attempt the network registration to the selected PLMN in Step S119.

The PLMN as the network registration object is selected on the basis of the available PLMN list obtained by the NAS 50 from the AS 60. The PLMN stored as the highest-level PLMN in the SIM card may be selected from among the PLMNs existing in the available PLMN list. Then, the NAS 50 requests the AS 60 to attempt the network registration to the selected PLMN. In this way, if the network registration is attempted to the PLMNs existing in the vicinity of the terminal, the network registration of the terminal may be performed.

In the above description, the terminal attempts the network registration to the 3G PLMN first and may receive the PLMN information for both 2G PLMNs and 3G PLMNs if the network registration to the 3G PLMN fails. However, the disclosure is not limited thereto. For example, the terminal may attempt the network registration to the 2G PLMN first and may receive the PLMN information for both 2G PLMNs and 3G PLMNs if the network registration to the 2G PLMN fails. Similarly, the technical spirit of the disclosure may be applied to the case where the terminal attempts the network registration to different-mode PLMNs, such as 3G and 4G PLMNs, 2G and 3G PLMNs, 2G and 4G PLMNs, 2G, 3G, and 4G PLMNs, and the like, without limitation as to which of the different-mode PLMNs in any scenario is first requested the network registration.

The disclosure may be applied to a mobile telecommunication system employing a multi-mode public land mobile network (PLMN). If the requested PLMN in charge of the communication region where the terminal is located provides the PLMN information to the terminal, the information on different-mode PLMNs adjacent to requested PLMN or the terminal is provided to the terminal by the requested PLMN. Accordingly, it is possible to perform the network registration by checking the PLMN status in the region where the terminal is located and by selecting a PLMN from among the PLMN information as the network registration object.

While the exemplary embodiments have been shown and described, it will be understood by those skilled in the art that various changes in form and details may be made thereto without departing from the spirit and scope of this disclosure as defined by the appended claims and their equivalents.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims and their equivalents.

What is claimed is:

1. A system to perform a network registration to a multi-mode public land mobile network (PLMN), comprising:
a first PLMN to transmit PLMN information comprising first PLMN information and second PLMN information on a second PLMN in a region near the first PLMN, the first PLMN corresponding to a first mode and the second PLMN corresponding to a second mode; and
a terminal to obtain an available PLMN list by acquiring the PLMN information from the first PLMN, to select the second PLMN corresponding to a network registration object by referring to the available PLMN list, and to attempt a network registration to the second PLMN.

2. The system of claim 1, wherein the PLMN information is transmitted to the terminal from the first PLMN via a broadcast control channel (BCCH).

3. The system of claim 1, wherein the terminal selects the second PLMN stored as a highest-level PLMN in a Subscriber Identity Module (SIM) card among PLMNs in the available PLMN list.

4. The system of claim 1, wherein the PLMN information indicates whether a mode does not include a PLMN in the region near the first PLMN.

5. A terminal to perform a network registration, comprising:
a processor;
a radio frequency transmitter/receiver; and
a Non Access Stratum (NAS) and an Access Stratum (AS),
wherein the terminal receives public land mobile network (PLMN) information from a first PLMN, the PLMN information comprising first PLMN information and second PLMN information on a second PLMN in a region near the first PLMN, obtains an available PLMN list from the PLMN information, selects the second PLMN corresponding to a network registration object by referring to the available PLMN list, and attempts a network registration to the second PLMN, and
wherein the first PLMN corresponds to a first mode and the second PLMN corresponds to a second mode.

6. The terminal of claim 5, wherein the PLMN information is received at the terminal via a broadcast control channel (BCCH).

7. The terminal of claim 5, wherein the terminal selects the second PLMN stored as a highest-level PLMN in a Subscriber Identity Module (SIM) card among PLMNs in the available PLMN list.

8. The terminal of claim 5, wherein the PLMN information indicates whether a mode does not include a PLMN in the region near the first PLMN.

9. A public land mobile network (PLMN) for a network registration in mobile telecommunications, comprising:
a radio frequency transmitter/receiver;
a processor; and
a memory to store PLMN information comprising its own PLMN information and information on a second PLMN in a region near the PLMN,
wherein the PLMN transmits the PLMN information to a terminal if a network registration to the PLMN by the terminal fails.

10. The PLMN of claim 9, wherein the PLMN information is transmitted via a broadcast control channel (BCCH).

11. The PLMN of claim 9, wherein the memory is arranged in a base station of the PLMN.

12. The PLMN of claim 9, wherein the memory is arranged in a base station controller of the PLMN.

13. The PLMN of claim 9, wherein the PLMN information indicates whether a mode does not include a PLMN in the region near the PLMN.

14. A method for a network registration to a multi-mode public land mobile network (PLMN), comprising:
attempting a network registration to a first PLMN;
receiving PLMN information comprising first PLMN information and second PLMN information on a second PLMN in a region near the first PLMN if the network registration to the first PLMN fails;
obtaining an available PLMN list from the PLMN information; and
attempting the network registration to the second PLMN selected as a network registration object by referring to the available PLMN list,
wherein the first PLMN corresponds to a first mode and the second PLMN corresponds to a second mode.

15. The method of claim 14, wherein attempting the network registration to the second PLMN comprises:
checking whether the second PLMN information is the same as PLMN information stored in a Subscriber Identity Module (SIM) card;
selecting the second PLMN stored as a highest-level PLMN in the SIM card as the network registration object; and
attempting the network registration to the second PLMN.

16. The method of claim 14, wherein the PLMN information is received via a broadcast control channel (BCCH).

17. The method of claim 14, wherein the PLMN information indicates whether a mode not does include a PLMN in the region near the first PLMN.
